(19) United States
(12) Patent Application Publication
(10) Pub. No.: US 2017/0293427 A1
(43) Pub. Date: Oct. 12, 2017

(54) MEMORY MODULE AND MEMORY SYSTEM INCLUDING THE SAME

(71) Applicant: SK hynix Inc., Gyeonggi-do (KR)

(72) Inventors: Jung-Hyun KWON, Gyeonggi-do (KR); Yong-Ju KIM, Gyeonggi-do (KR); Sang-Gu JO, Gyeonggi-do (KR); Jae-Sun LEE, Gyeonggi-do (KR); Do-Sun HONG, Gyeonggi-do (KR); Sung-Eun LEE, Gyeonggi-do (KR); Jing-Zhe XU, Gyeonggi-do (KR); Dong-Gun KIM, Gyeonggi-do (KR)

(21) Appl. No.: 15/247,619

(22) Filed: Aug. 25, 2016

(30) Foreign Application Priority Data
Apr. 11, 2016 (KR) 10-2016-0044078

(51) Int. Cl. G06F 3/06; G06F 12/06

(52) U.S. Cl. CPC G06F 3/061; G06F 3/0659; G06F 3/0688; G06F 12/0638; G06F 2212/205

(57) ABSTRACT

A memory module may include a first memory device configured to be controlled by a host memory controller, to transmit/receive data to/from the host memory controller in a first mode, and to transmit/receive data to/from a module memory controller in a second mode, a second memory device configured to be controlled by the module memory controller and to transmit/receive data to/from the module memory controller in the second mode, and the module memory controller configured to monitor control of the first memory device by the host memory controller, to exchange data such that the data is transmitted/received between the first memory device and the second memory device in the second mode, and to control the second memory device.

### CROSS-REFERENCE TO RELATED APPLICATIONS

The present application claims priority under 35 U.S.C, §119(a) to Korean Patent Application No. 10-2016-0044078, filed on Apr. 11, 2016, which is incorporated herein by reference in its entirety.

### BACKGROUND

### 1. Field

Exemplary embodiments of the present invention relate generally to a memory module and a memory system including the same.

### 2. Description of the Related Art

Memory chips mounted in most memory modules used in a data processing system, such as a personal computer (PC), a work station, a server computer, and a communication system are volatile memories. A volatile memory may perform a high speed operation, but is disadvantageous in that data is lost because a refresh operation is not possible when power is not supplied.

Recently, for solving this problem, a NVDIMM (Non-Volatile Dual In Line Memory Module) memory module has emerged. An NVDIMM is a memory module in which a nonvolatile memory has been mounted together with a volatile memory, and is used to compensate for the disadvantages of the volatile memory by backing up data of the volatile memory into the nonvolatile memory and/or to compensate for the disadvantages of the nonvolatile memory by using the volatile memory which has a faster speed than the nonvolatile memory as a cache of the nonvolatile memory having a slow speed but a large capacity. However, further improvements are needed for obtaining the full advantages of an NVIDMM.

### SUMMARY

Various embodiments of the present invention are directed to a memory module capable of substantially preventing performance reduction occurring in mode switching.

In an embodiment, memory module may include: a first memory device configured to be controlled by a host memory controller, to transmit/receive data to/from the host memory controller in a first mode, and to transmit/receive data to/from a module memory controller in a second mode; a second memory device configured to be controlled by the module memory controller and to transmit/receive data to/from the module memory controller in the second mode; and the module memory controller configured to monitor control of the first memory device by the host memory controller, to exchange data such that the data is transmitted/received between the first memory device and the second memory device in the second mode, and to control the second memory device in the second mode.

The first memory device may include a volatile memory device and the second memory device may include a nonvolatile memory device.

The first memory device may have an operation speed faster than an operation speed of the second memory device.

The first memory device may receive a command, an address, and a clock from the host memory controller.

The module memory controller may monitor the command, the address, and the clock transferred from the host memory controller to the first memory device.

The memory module may further include: a control buffer configured to buffer the command, the address, and the clock transferred from the host memory controller and transfer the buffered command, address, and clock to the first memory device; a data buffer configured to buffer the data transmitted/received by the first memory device; and a data selector configured to allow data to be transmitted/received between the data buffer and the host memory controller in the first mode and to allow data to be transmitted/received between the data buffer and the module memory controller in the second mode.

The second memory device may receive a command, an address, and a dock from the module memory controller and transmits/receives data to/from the first memory device through the module memory controller.

The memory module may be a DIMM (Dual In Line Memory Module) type.

In an embodiment, a memory system may include: a host memory controller; and a memory module, wherein the memory module may include: a first memory device configured to be controlled by the host memory controller, to transmit/receive data to/from the host memory controller in a first mode, and to transmit/receive data to/from a module memory controller in a second mode; a second memory device configured to be controlled by the module memory controller and to transmit/receive data to/from the module memory controller in the second mode; and the module memory controller configured to monitor control of the first memory device by the host memory controller, to exchange data such that the data is transmitted/received between the first memory device and the second memory device in the second mode, and to control the second memory device in the second mode.

In accordance with embodiments, it is possible to substantially prevent performance reduction occurring in mode switching in a memory module.

### BRIEF DESCRIPTION OF THE DRAWINGS

The above and other features and advantages of the present invention will become more apparent to those skilled in the art to which the present invention belongs by describing in detail various embodiments thereof with reference to the attached drawings in which:

FIG. 1 is a configuration diagram of a memory system, according to an embodiment of the present invention.

FIG. 2 is a diagram illustrating an operation of the memory system of FIG. 1, according to an embodiment of the present invention.

FIG. 3 is a configuration diagram of a memory system, according to another embodiment of the present invention.

FIG. 4 is a diagram illustrating an operation of the memory system of FIG. 3 according to an embodiment of the present invention.

### DETAILED DESCRIPTION

Various embodiment of the present invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of he present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to more clearly illustrate the various elements of the embodiments. For example, in the drawings, the size of elements and the intervals between elements may be exaggerated compared to actual sizes and intervals for convenience of illustration.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises”, “comprising” “includes” and “including” when used in this specification, specify the presence of the stated elements and do not preclude the presence or addition of one or more other elements. As used herein the term “and/or” includes any and all combinations of one or more of the associated listed items.

Unless otherwise defined, terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, an element described in connection with one embodiment may be used singly or in combination with other elements of another embodiment, unless otherwise specifically indicated.

Hereinafter, the various embodiments of the present invention will be described in detail with reference to the attached drawings.

In the following embodiments, a memory module performs operations in two modes as will be described below.

In the first mode a first memory device in the memory module communicates with a host. The first memory device may be, for example, a volatile memory device and may be part of a volatile memory module. In another embodiment, the first memory device may be a nonvolatile memory device and may be part of a nonvolatile memory module. In the first mode, data may be transmitted/received (i.e. transmitted and/or received) between the host and the first memory device. The operation of the first mode may be substantially equal to that of a conventional general memory module. That is, data may be written in the memory module according to an instruction of the host and the host may read the data stored in the memory module.

In the second mode the first memory device and a second memory device in the memory module communicate with each other. For example, in the second mode the first memory device may be a volatile memory device and the second memory device may be a nonvolatile memory device and may communicate with each other. For example, in the second mode, data may be transmitted/received between the first memory device and the second memory device. In the second mode data stored in the first memory device may be backed up to the second memory device when for example the first to memory device is a volatile memory device. Also, when the first memory device is used as a cache of the second memory device, i.e., when the first memory device is a volatile memory device and the second memory device is a nonvolatile memory device, the second mode may be used to fetch data stored in the second memory device to the first memory device or to write-back data changed in the first memory device to the second memory device.

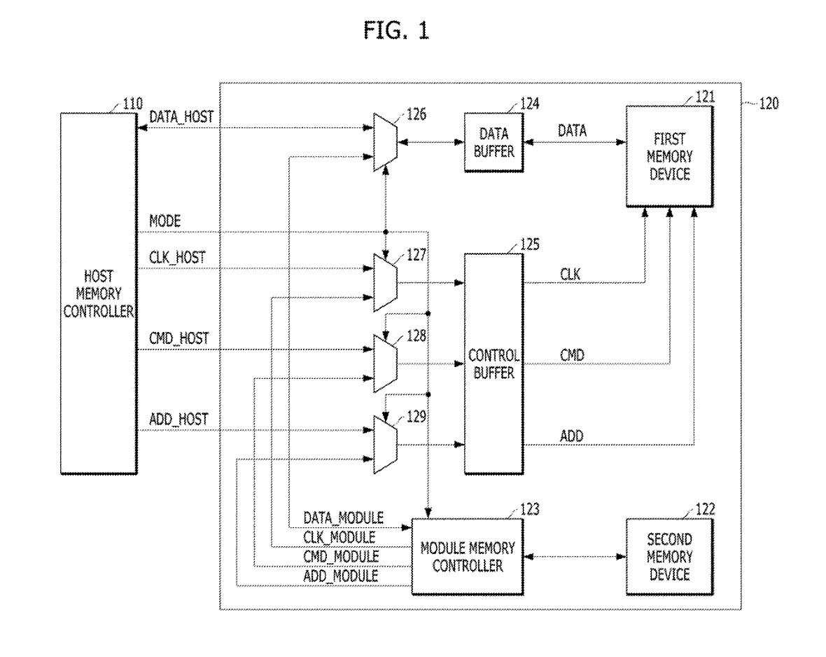

Referring now to FIG. 1 a memory system according to an embodiment of the present invention is provided.

According to FIG. 1, the memory system may include a host memory controller 110 and a memory module 120.

The host memory controller 110 may be a memory controller on a host. Any suitable memory controller may be used. In the first mode, data may be transmitted/received between the host memory controller 110 and a first memory device 121 under the control of the host memory controller 110. That is, in the first mode, a command CMD_HOST, an address ADD_HOST, and a dock CLK_HOST may be applied from the host memory controller 110 to the first memory device 121 and data DATA_HOST may be transmitted received between the host memory controller 110 and the first memory device 121. The host memory controller 110 may control switching between the first mode and the second mode through a mode signal MODE.

The memory module 120 may include the first memory device 121, a second memory device 122, a module memory controller 123, a data buffer 124, a control buffer 125, a data selector 126, a clock selector 127, a command selector 128, and an address selector 129. The memory module 120 may be a DIMM (Dual In Line Memory Module). FIG. 1 illustrates that one first memory device 121 and one second memory device 122 are included in the memory module 120; however, a plurality of first memory devices'and a plurality of second memory devices may also be included in the memory module 120.

The module memory controller 123 may be a memory controller on the memory module. Any suitable memory controller may be employed. The module memory controller may control the communications between the first and second memory devices 121 and 122 in the second mode.

For example, in the second mode, data may be transmitted/received between the first memory device 121 and the second memory device 122 under the control of the module memory controller 123. The data transmission/reception between the first memory device 121 and the second memory device 122 may be performed through the module memory controller 123. That is, in the second mode, a command CMD_MODULE, an address ADD_MODULE, and a clock CLK_MODULE may be applied from the module memory controller 123 to the first memory device, and data DATA_MODULE may be transmitted/received between the module memory controller 123 and the first memory device 121. Furthermore, in the second mode, a command, an address, and a clock may be applied from the module memory controller 123 to the second memory device 122 and data may be transmitted/received between the module memory controller 123 and the second memory device 122.

The control buffer 125 may buffer a clock a command, and an address to be applied to the first memory device 121, and transfer the buffered clock CLK, command CMD, and address ADD to the first memory device 121. The control buffer 125 is also called a register dock driver (RCD). Any suitable control buffer may be used.

The clock selector 127 may select a clock to be applied to the first memory device 121. In the first mode, the clock selector 127 may transfer the clock CLK_HOST of the host memory controller 110 to the control buffer 125 so that the clock CLK_HOST may be applied to the first memory device 121, and in the second mode, the clock selector 127 may transfer the clock CLK_MODULE of the module memory controller 123 to the control buffer 125 so that the clock CLK_MODULE may be applied to the first memory device 121.

The command selector 128 may select a command to be applied to the first memory device 121. In the first mode, the command selector 128 may transfer the command CMD_HOST of the host memory controller 110 to the control buffer 125 so that the command CMD_HOST may be applied to the first memory device 121, and in the second mode, the command selector 128 may transfer the command CMD_MODULE of the module memory controller 123 to the control buffer 125 so that the command CMD_MODULE may be applied to the first memory device 121.

The address selector 129 may select an address to be applied to the first memory device 121. In the first mode, the address selector 129 may transfer the address ADD_HOST of the host memory controller 110 to the control buffer 125 so that the address ADD_HOST may be applied to the first memory device 121, and in the second mode, the address selector 129 may transfer the address ADD_MODULE of the module memory controller 123 to the control buffer 125 so that the address ADD_MODULE may be applied to the first memory device 121.

The data buffer 124 may buffer the data DATA transmitted/received by the first memory device 121. Any suitable data buffer may be employed.

The data selector 126 may select a memory controller,i.e., the host memory controller 110 or the module memory controller 123. The selected memory controller may then transmit/receive data to/from (i.e. to and/or from) the first memory device 121. In the first mode, the data selector 126 may transmit/receive the data DATA_HOST, which is transmitted/received by the host memory controller 110, to/from the data buffer 124 so that the host memory controller 110 may transmit/receive data to/from the first memory device 121. In the second mode, the data selector 126 may transmit/receive the data DATA_MODULE, which is transmitted/received by the module memory controller 123, to/from the data buffer 124 so that the module memory controller 123 may transmit/receive data to/from the first memory device 121.

The first memory device 121 may transmit/receive data to/from the host memory controller 110 in the first mode, and may transmit/receive data to/from the second memory device 122 in the second mode. The first memory device 121 may be a memory having an operation speed faster than that of the second memory device 122. The first memory device 121 may be a volatile memory device such as a DRAM, a SRAM (synchronous RAM,) or a DDR SDRAM (double data rate synchronous dynamic RAM). In an embodiment the first memory device may be a DRAM. The first memory device 121 may be controlled by the host memory controller 110 in the first mode, and may be controlled by the module memory controller 123 in the second mode.

The second memory device 122 may transmit/receive data to/from the first memory device 121 in the second mode. The second memory device 122 may be a nonvolatile memory device, for example, may be one of a NAND FLASH, a NOR FLASH, a RRAM (Resistive RAM), a PCRAM (Phase Change RAM), a MRAM (Magnetic RAM) and a STT-MRAM (Spin Transfer Torque-MRAM). The second memory device 122 may be controlled by the module memory controller 123 in the second mode. The second memory device 322 may be a memory having an operation speed relatively slower than that of the first memory device 321. The second memory device 322 may be called a low-speed memory.

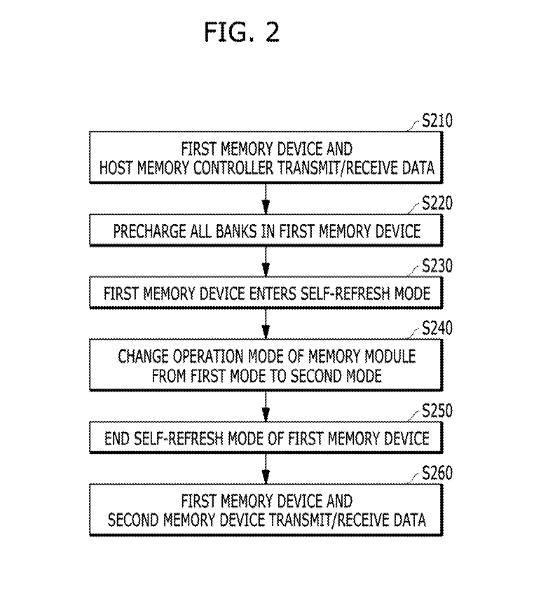

FIG. 2 is a flowchart illustrating the operation of the memory system of FIG. 1, according to an embodiment of the present invention.

Referring now to FIG. 2, in the first mode, the first memory device 121 and the host memory controller 110 may operate while transmitting/receiving the data DATA_HOST (S210). In the first mode, the first memory device 121 may perform an active operation, a read operation, a write operation and the like according to an instruction of the host memory controller 110.

For the switching of the first mode to the second mode, all memory banks in the first memory device 121 may be controlled in a precharge state (S220). In the state in which all the banks have been precharged, the first memory device 121 may enter a self-refresh mode (S230).

In the state in which the first memory device 121 has entered the self-refresh mode, the operation mode may be changed from the first mode to the second mode (S240). By changing the mode, the control signals of the clock CLK, the command CMD, the address ADD and the like applied to the first memory device 121 may be changed from the control signals CLK_HOST, CMD_HOST, and ADD_HOST of the host memory controller 110 to the control signals CLK_MODULE, CMD_MODULE, and ADD_MODULE of the module memory controller 123. Furthermore, a target to and/or from which the first memory device 121 transmits/receives data may be changed from the host memory controller 110 to the module memory controller 123.

After the operation mode is changed to the second mode, the self-refresh mode of the first memory device 121 may be ended (S250). Furthermore, the first memory device 121 may operate while transmitting/receiving the data DATA_MODULE to/from the second memory device 122 through the module memory controller 123 (S260).

As described in FIG. 2, in the memory system of FIG. 1, the switching of the first mode to the second mode should be performed in the state in which all the memory banks of the first memory device 121 have been precharged and the first memory device 121 has entered the self-refresh mode. This is because it is necessary to change the control signals after the first memory device 121 is allowed to remain in an asynchronous state due to a change between clock domains of the control signals CLK_HOST, CMD_HOST, and ADD_HOST, which are transferred to the first memory device 121 by the host memory controller 110 in the first mode, and clock domains of the control signals CLK_MODULE, CMD_MODULE, and ADD_MODULE which are transferred to the first memory device 121 by the module memory controller 123 in the second mode. Switching of the second mode to the first mode may also be performed in substantially the same manner as the switching of the first mode to the second mode.

In the memory system of FIG. 1, in the switching of the first mode to the second mode, since steps S220, S230, S240, and S250 should be performed, performance reduction due to mode switching may occur.

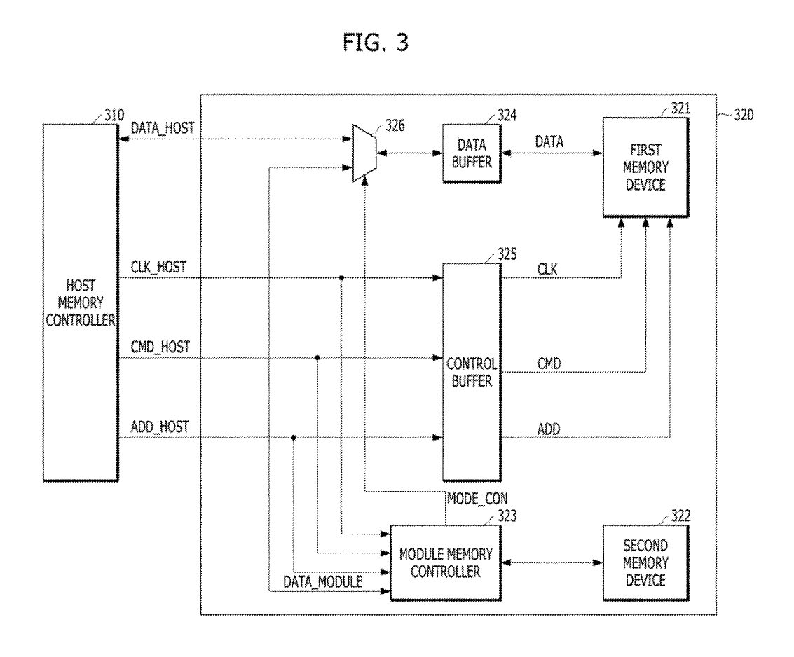

FIG. 3 is a configuration diagram of a memory system, according to another embodiment.

Referring to FIG. 3, the memory system may include a host memory controller 310 and a memory module 320.

The host memory controller 310 may be a memory controller on a host. The host memory controller 310 may control the operation of a first memory device in both a first mode and a second mode of operation. Any suitable memory controller may be used.

The first memory device 321 may be controlled by the host memory controller 310 in both a first mode and a second mode. In the first mode, data DATA_HOST may be transmitted/received between the host memory controller 310 and the first memory device 321 under the control of the host memory controller 310. In the second mode, the first memory device 321 transmits/receives data DATA_MODULE to/from a second memory device 322 through the module memory controller 323, wherein also in the second mode, the first memory device 321 may be controlled by the host memory controller 310. That is, in all the first mode and the second mode, a command CMD_HOST, an address ADD_HOST, and a clock CLK_HOST may be applied from the host memory controller 310 to the first memory device 321. The host memory controller 310 may control switching between the first mode and the second mode, and this may be performed by a combination of the command CMD_HOST and the address ADD_HOST. Of course, as with the embodiment of FIG. 1, the switching between the first mode and the second mode may also be controlled by transferring a separate mode signal MODE from the host memory controller 310 to the memory module 320.

The memory module 320 may include the first memory device 321, the second memory device 322, a module memory controller 323, a data buffer 324, a control buffer 325, and a data selector 326. The memory module 320 may be a DIMM (Dual In Line Memory Module). FIG. 3 illustrates that one first memory device 321 and one second memory device 322 are included in the memory module 320; however, a plurality of first memory devices and a plurality of second memory devices may also be included in the memory module 320.

The module memory controller 323 may be a memory controller on the memory module 320. The module memory controller 323 may monitor the control of the first memory device 321 by the host memory controller 310. That is, the module memory controller 323 may monitor the clock CLK_HOST, the command CMD_HOST, and the address ADD_HOST which are control signals applied to the first memory device 321 by the host memory controller 310. In the second mode, the module memory controller 323 may exchange (relay) data and control the second memory device 322 so that the data DATA_MODULE may be transmitted/received between the first memory device 321 and the second memory device 322. In the second mode, a command, an address, and a clock may be applied from the module memory controller 323 to the second memory device 322, and data may be transmitted/received between the module memory controller 323 and the second memory device 322. That is, in the second mode operation, the first memory device 321 is controlled by the host memory controller 310, but may transmit/receive the data DATA_{——}MODULE to/from the second memory device 322 through the module memory controller 323, and the second memory device 322 is controlled by the module memory controller 323 and may transmit/receive the data DATA_MODULE to/from the first memory device 321 through the module memory controller 323. Such control is possible because the module memory controller 323 monitors the control signals CLK_HOST, CMD_HOST, and ADD_HOST applied to the first memory device 321 by the host memory controller 310. The module memory controller 323 may determine mode switching through the monitored control signals CLK_HOST, CMD_HOST, and ADD_HOST of the host memory controller 310 and thus may control mode switching of the data selector 326 by using a mode switching signal MODE_CON.

The control buffer 325 may buffer the clock CLK_HOST, the command CMD_HOST, and the address ADD_HOST, which are transferred from the host memory controller and are to be applied to the first memory device 321, and transfer the buffered clock CLK, command CMD, and address ADD to the first memory device 321. The control buffer 325 is also called a register clock driver (RCD).

The data buffer 324 may buffer the data DATA transmitted/received by the first memory device 321.

The data selector 326 may select a memory controller which is to transmit/receive data to/from the first memory device 321. In the first mode, the data selector 326 may transmit/receive the data DATA_HOST, which is transmitted/received by the host memory controller 310, to/from the data buffer 324 so that the host memory controller 310 may transmit/receive data to/from the first memory device 321, and in the second mode, the data selector 326 may transmit/receive the data DATA_MODULE, which is transmitted/received by the module memory controller 323, to/from the data buffer 324 so that the module memory controller 323 may transmit/receive data to/from the first memory device 321.

The first memory device 321 may transmit/receive data to/from the host memory controller 310 in the first mode, and may transmit/receive data to/from the second memory device 322 in the second mode. The first memory device 321 may be a memory having an operation speed relatively faster than that of the second memory device 322. The first memory device 321 may be a volatile memory device, for example, a DRAM, a SRAM, a DDR SDRAM. In an embodiment the first memory device may be a DRAM. The first memory device 321 may be called a high-speed memory. The first memory device 321 may be controlled by the host memory controller 310 in the first mode and the second mode. Since the first memory device is controlled by the host memory controller 310 in all the first mode and the second mode, clock domains of the control signals CLK_HOST, CMD_HOST, and ADD_HOST need not to be changed in switching of the first mode to the second mode and switching of the second mode to the first mode, so that it is possible to substantially prevent performance reduction due to mode switching.

The second memory device 322 may transmit/receive data to/from the first memory device 321 in the second mode. The second memory device 322 may be a nonvolatile memory device, for example, may be one of a NAND FLASH, a NOR FLASH, a RRAM (Resistive RAM), a PCRAM (Phase Change RAM), a MRAM (Magnetic RAM), and a STT-MRAM (Spin Transfer Torque-MRAM). The second memory device 322 may be controlled by the module memory controller 323 in the second mode. The second memory device 322 may be a memory having an operation speed relatively slower than that of the first memory device 321. The second memory device 322 may be called a low-speed memory.

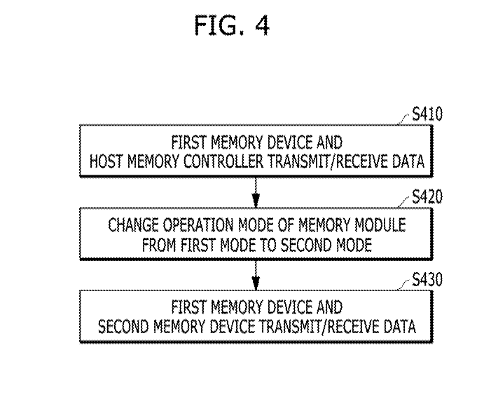

FIG. 4 illustrates the operation of the memory system of FIG. 3, according to an embodiment of the present invention.

Referring to FIG. 4, in the first mode, the first memory device 321 and the host memory controller 310 may operate while transmitting/receiving the data DATA_HOST (S410). In the first mode, the first memory device 321 may perform an active operation, a read operation, a write operation and the like according to an instruction of the host memory controller 310.

During the first mode operation, the operation mode may be changed from the first mode to the second mode (S420). When the host memory controller 310 notifies a mode a change through a combination of the command CMD_HOST and the address ADD_HOST, the module memory controller 323 monitoring the change, may recognize the mode change and control the data selector 326 to operate in the second mode. Even though the operation mode is changed from the first mode to the second mode, since there is no change in the control signals CLK_HOST, CMD_HOST, and ADD_HOST applied to the first memory device 321, instantaneous mode switching may be possible without any preparation process.

In the second mode, the first memory device 321 and the second memory device 322 may operate while transmitting/receiving the data DATA_MODULE (S430). In the second mode, the first memory device 321 is controlled by the host memory controller 310 and the second memory device 322 is controlled by the module memory controller 323, so that data may be transmitted/received between the first memory device 321 and the second memory device 322 through the module memory controller 323. The module memory controller 323 monitors the control of the first memory device 321 by the host memory controller 310, so that it is possible to control the second memory device 322 so that the data DATA_MODULE may be readily transmitted/received between the first memory device 321 and the second memory device 322.

In an embodiment, the first memory device 321 does not receive a command, an address, and a clock from the module memory controller 323.

Although various embodiments have been described for illustrative purposes, it will be apparent to those skilled in the art that various changes and modifications may be made without departing from the spirit and scope of the invention as defined in the following claims.

What is claimed is:

1. A memory module comprising:
a module memory controller;
a first memory device configured to be controlled by a host memory controller, to transmit and/or receive data to and/or from the host memory controller in a first mode, and to transmit and/or receive data to and/or from the module memory controller in a second mode; and
a second memory device configured to be controlled by the to module memory controller and to transmit and/or receive data to and/or from the module memory controller in the second mode.

2. The memory module of claim 1, wherein the module memory controller is configured to monitor control of the first memory device by the host memory controller, to exchange data so that the data is transmitted and/or received between the first memory device and the second memory device in the second mode, and to control the second memory device in the second mode.

3. The memory module of claim 1, wherein the first memory device includes a volatile memory device and the second memory device includes a nonvolatile memory device.

4. The memory module of claim 1, wherein the first memory device has an operation speed faster than an operation speed of the second memory device.

5. The memory module of claim 1, wherein the first memory device receives a command, an address, and a clock from the host memory controller and the module memory controller monitors the command, the address, and the clock transferred from the host memory controller to the first memory device.

6. The memory module of claim 4, further comprising:
a control buffer configured to buffer the command, the address, and the clock transferred from the host memory controller and transfer the buffered command, address, and clock to the first memory device;
a data buffer configured to buffer the data transmitted and/or received by the first memory device; and
a data selector configured to allow data to be transmitted and/or received between the data buffer and the host memory controller in the first mode and to allow data to be transmitted and/or received between the data buffer and the module memory controller in the second mode.

7. The memory module of claim 1, wherein the second memory device receives a command, an address, and a clock from the module memory controller and transmits and/or receives data to and/or from the first memory device through the module memory controller.

8. The memory module of claim 1, wherein the memory module is a DIMM.

9. A memory system comprising:
a host memory controller; and
a memory module comprising a module memory controller, a first memory device and a second memory device,
wherein the first memory device is configured to be controlled by the host memory controller, to transmit and/or receive data to and/or from the host memory controller in a first mode, and to transmit and/or receive data to and/or from the module memory controller in a second mode;
the second memory device is configured to be controlled by the module memory controller and to transmit and/or receive data to and/or from the module memory controller in the second mode, and
the module memory controller is configured to monitor control of the first memory device by the host memory controller, to exchange data so that the data is transmitted and/or received between the first memory device and the second memory device in the second mode, and to control the second memory device in the second mode.

10. The memory system of claim 9, wherein the first memory device includes a volatile memory device and the second memory device includes a nonvolatile memory device.

11. The memory system of claim 9, wherein the first memory device has an operation speed faster than an operation speed of the second memory device.

12. The memory system of claim 9, wherein the first memory device receives a command, an address, and a clock from the host memory controller.

13. The memory system of claim 12, wherein the module memory controller monitors the command, the address and the clock transferred from the host memory controller to the first memory device.

14. The memory system of claim 12, wherein the memory module further comprises:
a control buffer configured to buffer the command, the address, and the clock transferred from the host memory controller and transfer the buffered command, address, and clock to the first memory device;
a data buffer configured to buffer the data transmitted and/or received by the first memory device; and
a data selector configured to allow data to be transmitted and/or received between the data buffer and the host memory controller in the first mode and to allow data to be transmitted and/or received between the data buffer and the module memory controller in the second mode.

15. The memory system of claim 9, wherein the second memory device receives a command, an address, and a clock from the module memory controller and transmits and/or receives data to and/or from the first memory device through the module memory controller.

16. The memory system of claim 9, wherein the memory module is a DIMM.

17. A method of operating a memory module comprising:
transmitting and/or receiving a data between a host memory controller and a first memory device in a first mode; and
transmitting and/or receiving the data between the first memory device and a second memory device having an operation speed slower than an operation speed of the first memory device through a module memory controller in a second mode,
wherein the first memory device is controlled by the host memory controller in both the first mode and the second mode, and the second memory device i controlled by the module memory controller.

18. The method of claim 17, wherein transmitting and/or receiving the data between the first memory device and the second memory device comprises:
monitoring a control signal from the host memory controller to the first memory device by the module memory controller connected to the host memory controller; and
activating a data selector based on the control signal by the module memory controller to transmit and/or receive the data between the first memory device and the module memory controller,
wherein the data selector is connected to the host memory controller, the first memory device, and the module memory controller.

19. The method of claim 18, wherein the control signal includes at least one of a command, and an address transferred from the host memory controller to the first memory device.

20. The method of claim 17, wherein the first memory device does not receive a command, an address, and a dock from the module memory controller.
